(19) United States
(12) Patent Application Publication
(10) Pub. No.: US 2016/0139574 A1
(43) Pub. Date: May 19, 2016

(54) SMART HOME CONTROL APPARATUS AND METHOD

(71) Applicant: National Kaohsiung First University of Science and Technology, Kaohsiung City (TW)

(72) Inventors: Ching-Chang LEE, Kaohsiung City (TW); Meng-Ju TSAI, Kaohsiung City (TW)

(21) Appl. No.: 14/734,581

(22) Filed: Jun. 9, 2015

(30) Foreign Application Priority Data
Nov. 14, 2014 (TW) 103139544

(51) Int. Cl. G05B 15/02; H04L 12/28

(52) U.S. Cl. CPC G05B 15/02; H04L 12/2816

(57) ABSTRACT

Disclosed is a smart home control apparatus, including: a network input port, used for connecting a wired network and converting to a wireless network signal through a wireless network conversion technology; a receiving unit, receiving an instruction sent from an external apparatus through the wireless network signal; a signal conversion unit, converting the instruction received by the receiving unit to a corresponding instruction according to a communication protocol of a target apparatus; and a sending unit, sending the corresponding instruction to a controller electrically connected with the target apparatus, wherein the controller stores a status of the target apparatus into a storage unit after receiving the corresponding instruction and changing a status of the target apparatus.

### CROSS-REFERENCE TO RELATED APPLICATION

This application claims the benefit of Taiwan Patent Application No. 103139544, filed on Nov. 14, 2014, which is hereby incorporated by reference for all purposes as if fully set forth herein.

### TECHNICAL FIELD

The present invention relates to a smart home control apparatus, and more particularly to an apparatus and method for controlling household electronic supplies through a wireless network or the Internet of Things.

### BACKGROUND

With continuous development of network technologies, more and more terminal devices, such as lighting devices, household electrical appliances and sensor devices, will be connected to the Internet, to gradually form a network where things are connected (i.e., the Internet of Things), thus bringing about more convenience to people's daily life.

As development platforms, development languages and the like of devices produced by various terminal device manufacturers are inconsistent at present, these different types of terminal devices cannot be well integrated together and centralized management and control of the devices cannot be realized. Especially old electronic devices and analog electronic devices, in addition to needing additional loading of a signal conversion device, further need to use different receiving devices according to different protocols, for example, infrared (IR), radio frequency (RF) transmitting/receiving devices, etc. In general use, each electronic device has a dedicated remote control, and when someone intends to use a certain electronic device, he can control the electronic device only after finding the corresponding remote control, which also causes inconvenience to life.

Such a limitation hinders development of the Internet of Things to a large extent, so that people cannot experience the convenience that the Internet of Things brings about to people's daily life.

### SUMMARY

To achieve the above objective, the present invention provides a control apparatus, which can convert different protocols with a control method to achieve the purpose of managing terminal devices.

The present invention provides a smart home control apparatus, including: a network input port, used for connecting a wired network and converting to a wireless network signal through a wireless network conversion technology; a receiving unit, receiving an instruction sent from an external apparatus through the wireless network signal; a signal conversion unit, converting the instruction received by the receiving unit to a corresponding instruction according to a communication protocol of a target apparatus; and a sending unit, sending the corresponding instruction to a controller electrically connected with the target apparatus, wherein the controller stores a status of the target apparatus into a storage unit after receiving the corresponding instruction and changing a status of the target apparatus.

The present invention provides a smart home control method, applied to a smart home control apparatus, including: connecting a wired network and converting to a wireless network signal through a wireless network conversion technology by means of a network input port; receiving an instruction sent from an external apparatus through the wireless network signal by means of a receiving unit; converting the instruction received by the receiving unit to a corresponding instruction according to a communication protocol of a target apparatus through a signal conversion unit; and sending the corresponding instruction to a controller electrically connected with the target apparatus through a sending unit, wherein the controller stores a status of the target apparatus into a storage unit after receiving the corresponding instruction and changing a status of the target apparatus.

Through the smart home control apparatus and method provided in the present invention, apparatus signals of different protocols can be received only by use of one apparatus, and status management can be carried out, to make use statuses of various apparatuses absolutely clear.

Even if not in the home, a user can also grasp statuses of electronic devices in the home, so as to carry out energy management and reduce waste. The user does not need to rely on the controller of each apparatus to control the apparatus, and, when buying a new electronic apparatus, can begin operation only by adding a communication manner of the electronic apparatus to the control apparatus of the present invention, and if the present invention can be widely used, it will make the industry reduce production of remote controls of corresponding electronic products, thereby achieving effectiveness of promoting environmental protection.

### BRIEF DESCRIPTION OF DRAWINGS

FIG. 1 is a block diagram of elements of a smart home control apparatus according to the present invention;

FIG. 2 is an application diagram of a smart home control apparatus according to the present invention;

FIG. 3A is a control picture of a smart home control apparatus according to the present invention; and

FIG. 3B is a control picture of a smart home control apparatus according to the present invention.

### DETAILED DESCRIPTION OF DISCLOSED EMBODIMENTS

Content of the present invention will be described below in detail with reference to the accompanying drawings.

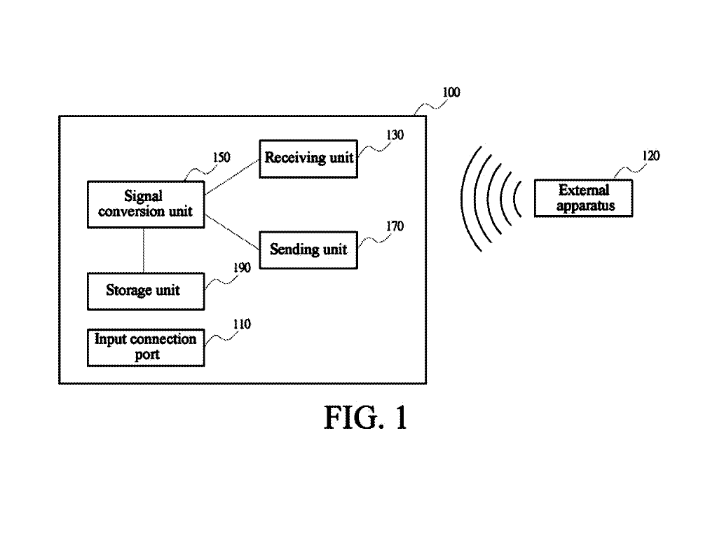

Referring to FIG. 1, FIG. 1 is a block diagram of elements of a smart home control apparatus according to the present invention, including: a smart home control apparatus 100, a network input port 110, a receiving unit 130, a signal conversion unit 150, a sending unit 170 and a storage unit 190.

The smart home control apparatus 100 may be a share device, a router, a hub or the like, and includes the network input port 110 for connecting a wired network (Ethernet), to make the smart home control apparatus 100 have a wireless access point with a function of converting the wired network to a wireless network; therefore, the smart home control apparatus of the present invention is a compound functional apparatus.

The receiving unit 130 receives an instruction sent from an external apparatus 120 through a wireless network signal, wherein the external apparatus 120 may be a computer, a mobile phone, a remote control or other electronic apparatuses with a wireless communication function, and more specifically, the external apparatus 120 uses an application program set thereon as a control interface that sends an instruction.

For example, a mobile phone can send an instruction to a specified apparatus through a control interface of a smart home control application program set thereon, wherein the instruction is converted through the smart home control apparatus of the present invention to a communication protocol used by the specified apparatus, and then sent to the specified apparatus, to make the specified apparatus perform corresponding operations according to the instruction.

The signal conversion unit 150 converts the instruction received by the receiving unit 130 to a corresponding instruction according to a communication protocol of a target apparatus, the sending unit 170 sends the corresponding instruction to a controller electrically connected with the target apparatus, for example, the instruction received is “turn on the air conditioner”, and the air conditioner can receive the instruction only through infrared communication; at this time, the signal conversion unit 150 converts the instruction of “turn on the air conditioner” to infrared data, and the infrared data is sent to the air conditioner through the sending unit 170, so that the air conditioner can operate according to the instruction.

In addition, the instruction may also be sent to electronic supplies originally without a remote control function (receiving an instruction), for example, an electric lamp may be electrically connected with a controller to have a function of receiving an instruction, while the type of the controller can be selected according to different types of electrical appliances, for example, the electric lamp may be electrically connected with a light modulator, and the light modulator may be an apparatus that receives an instruction through infrared communication (IR), radio frequency communication (RF), z-wave, Zigbee, Bluetooth, WIFI or the like, so that the electric lamp can become an apparatus that can receive control through the light modulator.

That is to say, after connecting a corresponding controller, each electrical appliance becomes an apparatus with a bidirectional communication function, instead of receiving an instruction unidirectionally, and it is also likely to transmit a current status of the electrical appliance to an external apparatus 120; the external apparatus also has a function of receiving statuses of various electrical appliances in addition to replacing the original function of sending an instruction by the old remote control.

Finally, after sending the instruction to the target apparatus, the external apparatus 120 will change a status of the target apparatus, for example, the status of the air conditioner is changed from OFF to ON, and the air conditioner temperature is adjusted from 27 degrees to 25 degrees; at this time, the smart home control apparatus 100 stores the current status of the air conditioner into a storage unit 190, and thus the user can know statuses of all electrical appliances that accept control through the application program set on the external apparatus 120.

The storage unit 190 may be a physical memory element located in the smart home control apparatus 100, for example, a hard disk, or a virtual memory element, for example, a cloud storage space.

In addition to that communication transmission between each electrical appliance and the smart home control apparatus 100 can be carried out according to a communication protocol used by the electrical appliance, when the electrical appliance is located in a range outside the communication protocol, for example, the upper limit of a distance of infrared communication is about one meter, the smart home control apparatus 100 of the present invention may also be automatically converted to a wireless network communication mode to carry out transmission with a controller of an electrical appliance; therefore, even if a distance set between the smart home control apparatus 100 of the present invention and each electrical appliance exceeds the original maximum distance of transmission of the communication protocol, communication still can be conducted through wireless network communication.

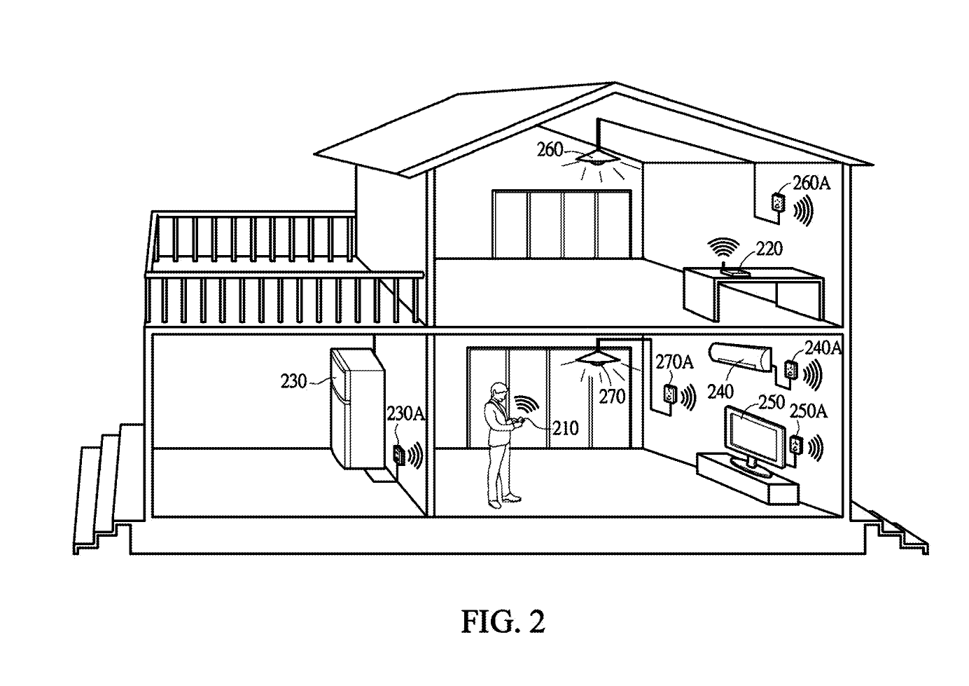

Referring to FIG. 2, FIG. 2 is an application diagram of a smart home control apparatus according to the present invention. The smart home control apparatus 220 according to the present invention may be disposed in any indoor position, and whether a user is in the house or not, he/she can use an apparatus with a network connection function, for example, a mobile phone 210, to connect the smart home control apparatus 220 and transmit an instruction or acquire statuses of electrical appliances in the house.

A refrigerator 230 is connected to a refrigerator controller 230A, air conditioner 240 is connected to an air conditioner controller 240A, a TV 250 is connected to a TV controller 250A, an electric lamp 260 is connected to an electric lamp controller 260A, and an electric lamp 270 is connected to an electric lamp controller 270A respectively, so that the electrical appliances in the house can have a function of receiving an instruction through their controllers.

That is to say, even if the user is in the first floor of the house, he/she can know the statuses of all the electrical appliances in the house through the mobile phone 210, and then adjusts brightness of the electric lamp 260 on the second floor or directly closes the electric lamp 260, to reduce energy waste.

In addition to electrical appliances run with electric power, it is also feasible to add controllers to doors and windows, curtains and the like for detecting open/closed statuses of the doors and windows and the like.

Therefore, no matter which type of electrical appliance is added in the house, the electrical appliance can accept an instruction from the smart home control apparatus 220 by using a corresponding connector to connect the electrical appliance, which not only is quite convenient and flexible during installation but also is very easy for removal. Even if out of home, the user can know and change the statuses of the electrical appliances in the house through the mobile phone 210, especially statuses of items closely related to home safety such as the gas stove, doors and windows, etc., thus reducing energy waste and avoiding unnecessary danger.

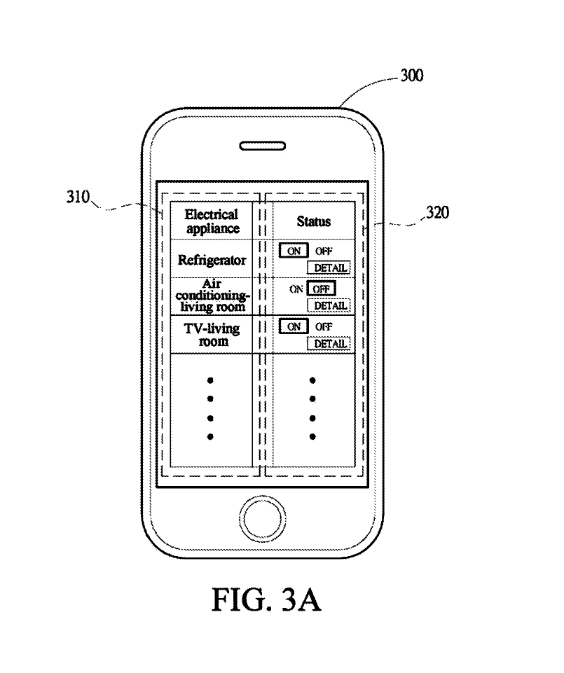

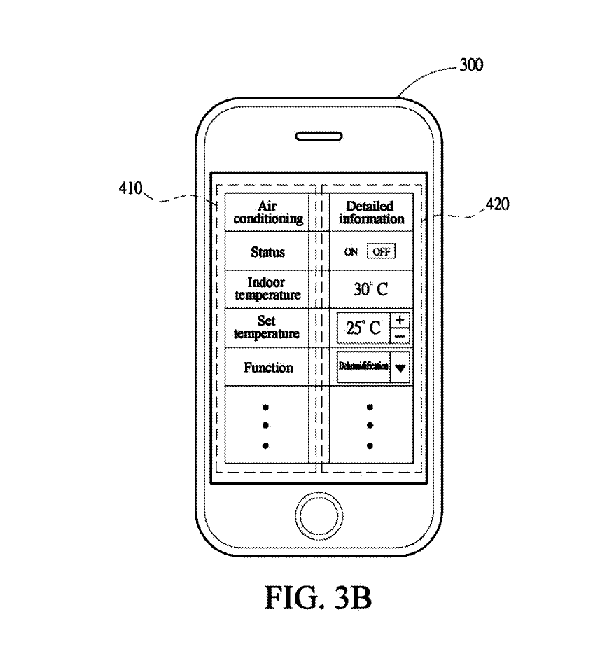

Referring to FIG. 3A and FIG. 3B, FIG. 3A and FIG. 3B are control pictures of a smart home control apparatus according to the present invention.

FIG. 3A and FIG. 3B illustrate a screen displayed by a mobile phone 300, including a device name column 310, a status column 320, a parameter column 410 and a setting column 420.

FIG. 3A illustrates a list of all electrical appliances and simple statuses thereof, on/off statuses of all the electrical appliances can be absolutely clear through the device name column 310 and the status column 320 of the screen, and detailed information thereof can be further understood and set; as shown in FIG. 3B, in addition to including the on/off status of the air conditioner, the indoor temperature sensed is further displayed, and the user can select a function and set the temperature, etc.

On the basis of the above, by means of the smart home control apparatus according to the present invention, the quality of smart home life can be achieved only by adding corresponding controllers without complicated operations of pipeline embedment and setting, therefore, any added or changed electrical appliance can easily become a part of smart home, which reduces the burden of installation and can also speed up promotion of general level of users' life quality.

Although the present invention has been disclosed with the foregoing embodiments, the embodiments are not intended to limit the present invention; equivalent replacements of variations and modifications made by any person skilled in the art without departing from the spirit and scope of the present invention still fall within the patent protection scope of the present invention.

What is claimed is:

1. A smart home control apparatus, comprising:
a network input port, used for connecting a wired network and converting to a wireless network signal through a wireless network conversion technology;
a receiving unit, receiving an instruction sent from an external apparatus through the wireless network signal;
a signal conversion unit, converting the instruction received by the receiving unit to a corresponding instruction according to a communication protocol of a target apparatus; and
a sending unit, sending the corresponding instruction to a controller electrically connected with the target apparatus,
wherein the controller stores a status of the target apparatus into a storage unit after receiving the corresponding instruction and changing a status of the target apparatus.

2. The smart home control apparatus according to claim 1, wherein the target apparatus comprises a plurality of electronic apparatuses of various different communication protocols.

3. The smart home control apparatus according to claim 2, wherein the communication protocols comprise infrared, radio frequency and WIFI.

4. The smart home control apparatus according to claim 1, wherein the smart home control apparatus has a function of a router at the same time.

5. The smart home control apparatus according to claim 1, wherein the external apparatus can have access to the storage unit through the wireless network signal so as to obtain the status of the target apparatus.

6. A smart home control method, applied to a smart home control apparatus, comprising:
connecting a wired network and converting to a wireless network signal through a wireless network conversion technology by means of a network input port;
receiving an instruction sent from an external apparatus through the wireless network signal by means of a receiving unit;
converting the instruction received by the receiving unit to a corresponding instruction according to a communication protocol of a target apparatus through a signal conversion unit; and
sending the corresponding instruction to a controller electrically connected with the target apparatus through a sending unit,
wherein the controller stores a status of the target apparatus into a storage unit after receiving the corresponding instruction and changing a status of the target apparatus.

7. The smart home control method according to claim 6, wherein the target apparatus comprises a plurality of electronic apparatuses of various different communication protocols.

8. The smart home control method according to claim 7, wherein the communication protocols comprise infrared, radio frequency and WIFI.

9. The smart home control method according to claim 6, wherein the smart home control apparatus has a function of a router at the same time.

10. The smart home control method according to claim 6, wherein the external apparatus can have access to the storage unit through the wireless network signal so as to obtain the status of the target apparatus.
